(19) United States
(12) Patent Application Publication
(10) Pub. No.: US 2010/0143827 A1
(43) Pub. Date: Jun. 10, 2010

(54) Methods of Making Holographic Devices

(76) Inventors: Adrian Martin Horgan, Surrey (GB); Alexander James Marshall, Cambridge (GB); Simon Kew, Cambridge (GB)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/596,558

(22) PCT Filed: Apr. 17, 2008
(86) PCT No.: PCT/GB08/01371

§ 371 Date: Jan. 13, 2010

(30) Foreign Application Priority Data
Apr. 20, 2007 (GB) 0707692.0

(51) Int. Cl. G03H 1/04; G03H 1/02; G03H 1/00

(52) U.S. Cl. 430/2; 359/2

(57) ABSTRACT

A method of making a holographic device (4) comprises the steps of: forming a heterogeneous support medium (2) having at least two regions (1) which are heterogeneous; placing the heterogeneous support medium under recording conditions, e.g. in a liquid X, which are selected to change one or more physical properties of the heterogeneous support medium, wherein the extent or nature of the change in the physical property or physical properties is different in at least two of the heterogeneous regions; recording a holographic image in the heterogeneous support medium while it is under recording conditions; and removing the heterogeneous support medium from recording conditions. Such a device can be used for security and authentication.

### FIELD OF THE INVENTION

The present invention relates to a method of making holographic devices that are useful in the field of security and in identifying and authenticating complex liquid mixtures.

### BACKGROUND OF THE INVENTION

Holographic security labels are currently used to authenticate a wide range of products. A variety of levels of security can be provided by a combination of multiple images, image complexity, multiple colours, messages, coded messages, overt images, covert images and label removal prevention. Introducing complexity in one or more of these ways means that copying the label becomes more difficult and therefore that counterfeiting of the product is reduced.

WO05/122099 is concerned with providing holographic devices which are suitable for use in authenticating various articles and products. The devices combine a medium comprising a holographic image with an image concealer that acts to attenuate the image. The image concealer is one which is can be degraded, removed or have its refractive index altered by the action of a specific chemical or mixture of chemicals. Hence, it is necessary to contact the device with the specific chemical or mixtures of chemicals to remove or alter the attenuation properties of the image concealer to reveal the image. Such devices provide reasonable security against counterfeiting but are relatively difficult to manufacture due to the need to include an image concealer.

However, despite current efforts, counterfeiting of holographic devices and associated products still occurs on a scale which has a negative impact on the safety of the public and the economic viability of many sections of the business community.

Counterfeiting is particularly harmful when authenticity of the product is very important, for example in the case of a pharmaceutical product or medical device, or where the product is particularly valuable, such as with some electrical devices, jewelry or fashion items. Piracy has caused the perfume industry losses of hundreds of millions of pounds in recent years. There is, therefore, a desire to provide holographic devices that are more difficult to copy than has previously been the case.

Holographic devices are also known in the field of chemical analysis. So called “holographic sensors” are used to detect the presence of and sometimes the concentration of particular analytes. These devices operate by modifying the optically diffractive properties of diffraction gratings and other surface structures in order to sense the presence or concentration of chemical analytes.

For example, WO95/26499 discloses a holographic sensor. The sensor comprises a holographic support medium and, disposed throughout its volume, a hologram. The support medium interacts with an analyte, resulting in a variation of a physical property of the medium. This variation induces a change in an optical characteristic of the holographic element, such as its polarisability, reflectance, refractance or absorbance. If any change occurs whilst the hologram is being replayed (e.g. using incident broad band, non-ionising electromagnetic radiation), then a colour change, for example, may be observed using an optical detector. The optical detector may be a spectrometer or simply the human eye.

WO99/63408 describes a method of producing a holographic sensor. A sequential treatment technique is used wherein the polymer film is made first and sensitive silver halide particles are added subsequently. These particles are introduced by diffusing soluble salts into the polymer matrix where they react to form an insoluble light-sensitive precipitate. The holographic image is then recorded under conventional conditions.

WO01/50113 is concerned with providing a complex sensor comprising a support medium which has a multiplexed image display. The different images are recorded when the support material is in different states of swelling. During use the different images become visible under different conditions. The support medium is homogeneous.

WO06/008524 is concerned with providing a holographic sensor which can give a scaled response on interaction with an analyte, for example, a sensor that has a sensitivity gradient. This is achieved by using a support medium that has heterogeneous properties. A holographic image is recorded in the support medium in a conventional way.

There is a need for holographic sensors that provide a greater degree of security against counterfeiting while being convenient to manufacture.

### SUMMARY OF THE INVENTION

According to a first aspect, the present invention provides a method of making a holographic device, the method comprising the steps of:

forming a heterogeneous support medium having at least two regions which are heterogeneous;

placing the heterogeneous support medium under recording conditions which are selected to change one or more physical properties of the heterogeneous support medium, wherein the extent or nature of the change in the physical property or physical properties is different in at least two of the heterogeneous regions;

recording a holographic image in the heterogeneous support medium while it is under recording conditions; and

removing the heterogeneous support medium from recording conditions.

According to a second aspect, the invention provides a method of verifying the authenticity of a holographic device or of a recording condition, the method comprising the steps of:

making a holographic device according to the first aspect of the invention;

placing the holographic device under recording conditions; and

observing the holographic image.

According to a third aspect, the invention provides a holographic device obtainable by a method according to the first aspect of the invention.

According to a fourth aspect, the invention relates to the use of a holographic device according to the third aspect of the invention as a label to verify the authenticity of a product.

According to a fifth aspect, the invention relates to the use of a holographic device according to the third aspect of the invention to identify the recording condition, preferably wherein the recording condition includes immersion in a recording liquid.

The holographic devices of the present invention offer a very high level of security against counterfeiting due to the combination of using a heterogeneous support medium and selecting particular conditions under which a holographic image is recorded (hereinafter referred to as the recording conditions). The recording conditions are selected to provide the effect of changing one or more physical properties of the heterogeneous support medium to a different extent or in a different way in each heterogeneous region.

This means that the holographic image can only be revealed in its entirety when the device is subjected to the precise recording conditions used during manufacture, which are not apparent from the device itself. Therefore, the device can be used in applications to authentic a product to which it is attached. It can also be attached to a product to act as a warranty indicator, a proof of purchase indicator, or an expiry date indicator.

Using a heterogeneous support medium with selected recording conditions to manufacture a holographic device is a relatively simple (and hence environmentally and economically advantageous) way to provide enhanced security and does not involve the use of additional materials such as image concealers that have previously been used in holographic security labels.

The holographic devices of the invention can also be used to authenticate a liquid, by using immersion in the liquid as a recording condition. The authenticity of the liquid is then determined by immersing the holographic device in it and observing the holographic image. For example, in this context the device can be used to distinguish one liquid drug from another or, in another commercial context, Coca Cola® from Pepsi Cola®, or to check the alcohol levels in a bottle of spirits to ensure the contents are authentic. The invention can also be used to identify or authenticate perfumes which are complex mixtures of components, by using a particular perfume (such as, for example, Chanel No 5® as the recording liquid.

In a preferred embodiment, the device can also be used to monitor an industrial process to ensure that a liquid produced at a particular point in the process has the number and level of components which is expected. This embodiment is particularly useful in processes for making beverages, which are commonly complex mixtures of components.

### DETAILED DESCRIPTION OF THE INVENTION

The method of the invention involves forming a heterogeneous support medium. By heterogeneous support medium we mean a material in which a holographic image can be recorded that has at least two regions that do not have the same physical or chemical properties as one another. Usually the support medium is a polymeric film. The more complex the heterogeneity of the support medium, the more difficult the device will be to copy. Therefore, preferably the heterogeneous support medium has more than two heterogeneous regions, preferably at least 6, 10, 24 or even 50 heterogeneous regions. Preferably the heterogeneity of the support medium will be random or in a complex pattern rather than being stepwise or gradual as this will make the device more difficult to copy.

There are various ways of achieving heterogeneity. Some ways of achieving heterogeneity are disclosed in WO06/008524 which is hereby incorporated by reference. In particular, the heterogeneous support medium may be formed by:

polymerisation of monomers, wherein different monomers are used to form each heterogeneous region of the support medium; and/or

polymerisation of monomers, wherein different polymerisation reaction conditions are used to form each heterogeneous region of the support medium; and/or

modification of a support medium by introducing into the support medium a component and reacting the component with the support medium or with a second component present in the medium, wherein a different extent of reaction occurs to form each heterogeneous region of the support medium. This can be achieved by varying the concentration of or duration of contact with the component.

In the modification embodiment, a homogeneous polymer can be made heterogeneous by adding a monomer to particular regions and cross-linking it to give hydrogels. For example, a homogeneous gelatine polymer can be produced and then spotted with a component that reacts with the gelatine to derivatise it in the spotted areas only hence forming a heterogeneous polymer.

In the most preferred embodiment, the heterogeneous support medium is formed by the polymerisation of monomers, wherein different monomers are used to form each heterogeneous region of the support medium. Hence, the different regions comprise different polymers entirely. This allows for a greater degree of heterogeneity than can be provided by using the same polymer in each region and modifying its properties.

When different polymers are used in the heterogeneous regions, the support medium is usually discontinuous, with the regions forming defined “spots” on a supportive substrate. The support substrate can be made of any suitable material such as glass or plastics. The spots can be any shape or size such as round or square. It is preferable that the spots are arranged so that they are close to one another so that they give an image which appears to be substantially continuous to the naked eye. This allows for the image to be more easily observed than if there are large gaps between the spots.

It is advantageous to use the different ways of providing homogeneity in combination. For example, different monomers can be used in different regions, and can be polymerised under different conditions, and can be subsequently modified.

Any polymeric materials that are conventionally used to make support media can be used. WO06/008524 discloses the formation of a heterogeneous support medium by using different reaction conditions or modifying a support medium. Polymerisation methods can include free radical polymerisation, controlled radical polymerisation, atom transfer polymerisation or anionic polymerisation.

Any monomers that create a polymer in which a holographic image can be recorded can be used. For example, suitable monomers include acid-containing monomers, metal salts, acrylic monomers (neutral, monofunctional), adhesion-promoting monomers, amine-containing monomers, crosslinking acrylic monomers, difunctional, crosslinking acrylic monomers, multifunctional, dual reactive acrylic monomers, epoxides/anhydrides/imides, fluorescent acrylic monomers, fluorinated acrylic monomers, high/low refractive index monomers, hydroxyl-containing monomers, miscellaneous monomers, mono and difunctional glycol oligomeric monomers, styrenic monomers, UV (light) active monomers, vinyl and ethenyl monomers.

Alternatively, polymer hydrogels can be made by non-polymerisation methods such as “click chemistry” which is known in the art such as in the article “Poly(vinyl alcohol)—Based Hydrogels formed by “Click Chemistry” by Dimitri A Ossipov and Joens Hilborn in Macromolecules 2006, 39, 1709-1718”.

The polymeric support medium preferably comprises functional groups that can be readily modified. For example, it may be formed from hydroxyethyl methacrylate (“HEMA”), aminoethyl methacrylate (“AEMA”) and/or ethylene diglycol methacrylate (“EDMA”) monomers. A resultant polymer comprises an amino functional group which may be readily modified. Amino groups may be modified, for example, using an anhydride such as acetic anhydride, succinic anhydride or 4-nitrophthalic anhydride.

The heterogeneous support medium may be created by introducing a component which is an additional monomer to the medium, followed by further polymerisation. For example, the additional monomer may be obtained by deprotecting a protected monomer already present in the polymerisation mixture. Monomers may be protected with groups such as N-(t-butoxycarbonyl), prior to the initial polymerisation. The polymerised mixture will then comprise polymerised and non-polymerised regions. The protected monomers can then be selectively deprotected and polymerised. This allows accurate control of the physical properties in different regions.

Alternatively, the additional component may be a cross-linker, the polymer comprising cross-linkable groups which can be selectively cross-linked. Cross-linking is another means of precisely controlling the polymer structure and thus the sensitivity of the holographic element. Particularly preferred is photochemical cross-linking involving the use of a variable (e.g. grey-scale) mask, to achieve the desired heterogeneity.

The physical properties of the support medium can be controlled using an agent such as a chromate. The use of a chromate with gelatine-based support media (in particular those cross-linked with formaldehyde) may reduce the sensitivity of the element, while at the same time increasing its replay wavelength.

The heterogeneous support medium is placed under recording conditions which are selected to change one or more physical properties of the heterogeneous support medium, wherein the extent or nature of the change is different in at least two of the heterogeneous regions. A “change” in a physical property refers to a change compared to when the support medium is under ambient conditions of pressure, temperature and magnetism and either in a dry state or immersed in water or a buffer solution.

It is not necessary for all of the heterogeneous regions to undergo a change in physical properties under any particular recording conditions. Often there will be multiple regions in the form of spots which are heterogeneous and wherein only about half or fewer of the spots will change their physical properties differently from one another on interaction with the recording conditions. However, preferably at least 20%, 50%, 80% or even 90% of the heterogeneous regions respond differently to the recording conditions. Preferably, the recording conditions are selected from one or more of non-ambient temperature, non-atmospheric pressure, a magnetic field, an electric field and immersion in a recording liquid.

This is in contrast to known methods for making holographic devices where the holographic image is recorded at atmospheric pressure and temperature, either with the support medium in a dry state or in a liquid that has not been selected to interact differently with heterogeneous regions of the support medium. Conventionally, holographic images are recorded when the support medium is in water or in a buffer solution.

After recording an image under particular conditions and removing the device from the conditions, the image may be completely invisible or partially invisible. If an additional image has been recorded under ambient conditions, a mixture of images may be apparent. Only by returning the device to the recording conditions will the complete and correct image be apparent.

In conventional holographic devices, it has been desirable to record an image that is visible once it has been developed and the device has been removed from the recording liquid, if one is used. Hence, by deliberately recording the image under conditions which mean that it will not be fully visible under ambient conditions, i.e., in normal use, the present invention is radically different from known methods of making holographic sensors.

By non-ambient temperature, we mean a temperature below 10° C. or above 35° C. By a non-atmospheric pressure, we mean a pressure of less than 0.8 atm or above 1.2 atm. The temperature and pressure can have a effect on the physical properties of heterogeneous polymers, causing them then swell, contract or undergo a phase transition.

A magnetic field can be used in the invention to manipulate the properties of heterogeneous regions of the support medium in a differential manner. For example, particles of a magnetic material may be dispersed throughout the support medium with different concentrations in heterogeneous regions or in some regions only. For example, the holographic image can be recorded when the support medium is in a wet, dry or partially wet state with an array of magnets which have different strengths positioned around the medium. Hence, the action of a magnetic field would have a different effect on the physical properties of the support medium in the different regions. A similar effect can be achieved using a support medium that is electrically responsive, with differential electric fields.

In a preferred embodiment, the recording conditions include immersion in a recording liquid. Preferably, the recording liquid comprises at least 3, preferably at least 5, most preferably at least 10, 25 or even 50 components, wherein each component interacts with the heterogeneous support medium to change one or more of its physical properties and wherein the extent or nature of the interaction of each of the heterogeneous region of the support medium is different.

It is important that the recording liquid is a complex mixture containing at least 3 components that interact with the support medium, as this leads to a high degree of security. Preferably, the recording liquid contains many components which means that the interaction with the support medium is complex. This, in combination with the heterogeneous nature of the interaction with the support medium, makes the device extremely difficult to copy.

The components of the recording liquid may interact physically with the support medium to change its physical characteristics. For example, if the support medium is hydrophilic, a polar solvent can be added to make the liquid swell. Alternatively, the medium can be contracted in a non-polar solvent.

In a further embodiment, the support medium undergoes a chemical reaction with one or more components in the recording liquid. This occurs when the support medium is designed to have an enhanced response upon reaction with one of the components which is termed an analyte, i.e. is specifically sensitive to the analyte. This generally occurs when some regions of the medium have been derivatised to react with particular compounds which are present in the recording liquid. The reaction must be reversible. Such systems are commonly referred to as holographic sensors as discussed above.

The heterogeneous medium preferably has discrete regions which interact with a component in the mixture (i.e., acts as a “sensor” for an “analyte”) and regions which do not do anything at all, as well as regions that do not respond to a particular component in the mixture (i.e., sense) but change their swelling state purely on hydrophobicity/hydrophilicity, temperature or other physical grounds, i.e., a non-sensory response.

A holographic image is recorded in the heterogeneous support medium while it is under recording conditions. In one embodiment of the invention, several different images can be recorded, and/or the image or images can be recorded under several different recording conditions. Typically, a holographic recording material is disposed in the support medium. This is usually a silver halide. This can be achieved by diffusing soluble salts into the polymer matrix where they react to form an insoluble light-sensitive precipitate, e.g. as disclosed in WO99/63408.

Alternatively, a silver-free technique of the type described in WO2004/081676 can be used to create single holograms with at least two distinct heterogeneous regions. The concept is based on the use of one sensitivity in the initial polymer (P1) and a second sensitivity in the fringes of the polymer (P2), as described in WO06/008524.

According to second, fourth and fifth aspects, the invention can be used to verify the authenticity of a holographic device or of a recording condition. This is due to the fact that the holographic image is only revealed by placing the holographic device under recording conditions. This is particularly useful when the recording condition includes immersion in a liquid.

In one embodiment, where the authenticity of a device is in doubt, the device can be immersed in a liquid which is known to be the recording liquid. The image will only be shown if the holographic device was made using that recording liquid. Hence this can be used to authenticate the device. Such devices can be used as security labels on products. A sample of the recording liquid can be supplied to the distributor or end retailer so that they could check the authenticity either at periodic intervals and/or if the authenticity of the stock came into question.

Alternatively, where the authenticity of a liquid is in doubt, a holographic device of known authenticity can be used to test the liquid and, if the holographic image is fully visible, the liquid can be identified as authentic. This can be used, for example, to distinguish a particular liquid product such as a perfume, medicament or cosmetic product from a counterfeit version of that product that is not identical.

The invention also relates to a holographic device which is obtainable by the method of the invention. As the method of manufacture has the effect of modifying the image in the final device, such devices are physically distinct from devices that have been made by any conventional method.

The holographic image in the sensor of the invention can be generated by the diffraction of light. The holographic image may only be visible under magnification, or may be viewable under white light, UV light or infra-red radiation or under specific temperature, magnetism or pressure conditions. The holographic image is preferably of an object or gives a 2- or 3-dimensional effect.

The holographic device may further comprise means for producing an interference effect when illuminated with laser light, preferably wherein the means comprises a depolarising layer.

The holographic image can be detected by the naked eye or by using a device. The device is preferably selected from the group consisting of an optical reader, a mobile phone, a computer and a digital camera. It is envisaged that any type of computer can be used, such as a laptop, a desktop, or a hand held device such as a personal digital assistant (PDA) which is a personal organizer device.

The image should be clear and is preferably in the visible region of the electromagnetic spectrum. This gives an accurate and reliable readout that can be observed by the naked eye. To help ensure that this is achieved, the holographic device preferably has an optical filter thereon. The optical filter should cover some or all of the surface (or surfaces) of the holographic device which are observed to monitor analyte interaction.

The filter can be a lowpass filter (which allows radiation below a certain wavelength to pass through it), a highpass filter (which allows radiation above a certain wavelength to pass through it), or a bandpass filter (which allows radiation having a wavelength within a certain band, or certain bands in the case of a multi-bandpass filter, to pass through it). Hence, the use of such filters controls the frequency of the light that reaches the holographic device. The holographic image in the holographic device acts like a bandpass reflector so the reflection wavelength of the holographic image must be in the region of the filtered light to be transmitted back from the holographic device to the observer or detector.

Filters are selected to provide a cut-off point for light of a high or low wavelength or both so can ensure that any response is in a particular range, for example, the visible range. They can be used to distinguish between different responses (for example to different analytes or analyte concentrations) which occur at different wavelength. They can also be used to prevent an ambiguous response if the holographic device is used in non-optimal light conditions (for example, with monochromatic light). Optical filters can be specifically engineered to optimise the observed response to a specific analyte.

A transparent substrate is usually used in combination with an optical filter and is positioned between the holographic device and the filter. Specular reflections from the filter and the transparent substrate are not observed.

An article comprising a holographic device according to the invention can be used in various fields. Such an article may be a transaction card, banknote, passport, identification card, smart card, driving license, share certificate, bond, cheque, cheque card, tax banderole, gift voucher, postage stamp, rail or air ticket, telephone card, lottery card, event ticket, credit or debit card, business card, or an item used in consumer, brand or product protection for the purpose of distinguishing genuine products from counterfeit products or identifying stolen products.

Alternatively the article may be an item of intelligent packaging. “Intelligent packaging” refers to a system that comprises part of, or an attachment to, a container, wrapper or enclosure, to monitor, indicate or test product information or quality or environmental conditions that will affect product quality, shelf life or safety and typical applications, such as indicators showing time-temperature, freshness, moisture, alcohol, gas, physical damage and the like.

The invention can be used with an article which is an industrial or handicraft item comprising a decorative element, selected from items of jewelry, items of clothing (including footwear), accessories (such as handbags and watches), consumer goods (including DVDs, compact discs and computer programs), beverages (including spirits such as whisky), perfumes, fabric, furniture, toys, gifts, household items (including crockery and glassware), architecture (including glass, tile, paint, metals, bricks, ceramics, wood, plastics, waxes and other internal and external installations), art (including pictures, sculpture, pottery and light installations), stationery (including greetings cards, letterheads and promotional material) and sporting goods, or an article which is a product or device for use in agricultural studies, environmental studies, pharmaceuticals, human or veterinary prognostics, theranostics, diagnostics, therapy, chemical analysis or petrochemical analysis, especially which is a test strip, chip, cartridge, swab, tube, pipette, contact lens, sub-conjunctival implant, sub-dermal implant, breathalyser, catheter or a fluid sampling or analysis device. The holographic device of the invention can be included on a transferable holographic film. The film is preferably present on a hot stamping tape. The security of an article can be enhanced by transferring onto the article the holographic device from the film.

The invention also relates to a product comprising a holographic device of the invention which is capable of generating data from said holographic device and to a system which uses data generated by such a product for data storage, control, transmission, reporting and/or modelling.

### DESCRIPTION OF THE DRAWINGS

FIG. 1 is an illustration of a process according to the invention. In this process, a glass or plastics substrate 2 is provided with heterogeneous spots of a polymeric support material 1. In step A, the substrate 2 with the heterogeneous spots 1 is immersed in a complex recording liquid X and an image of a Smart Holograms logo is recorded. Wording, images or a plain mirror may be used for the recording. In the latter case, the spots can appear as different colours. Only by immersing the device in liquid X would the right pattern and colour of spots be obtained. The holographic device is then removed from the recording liquid X and, as the physical properties of the heterogeneous spots change, the complete recorded image is no longer visible; it may be partially visible, or completely invisible. In step B, the holographic device is immersed again in the complex recording mixture X which reveals the holographic image on the holographic device 4.

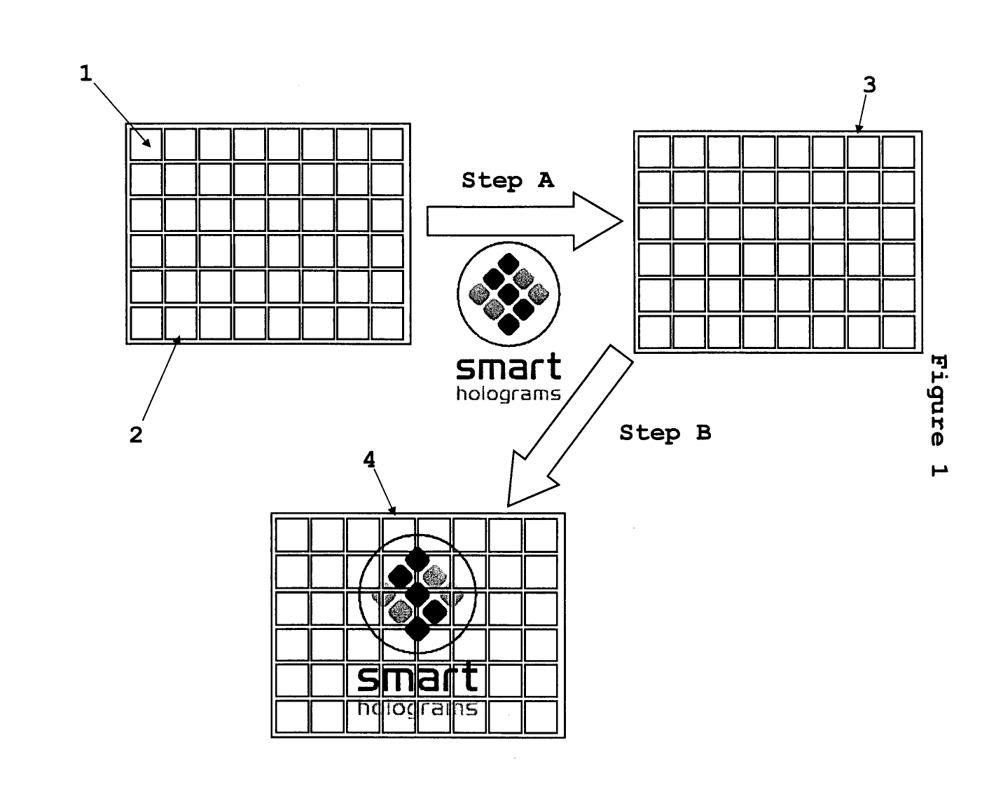

1. A method of making a holographic device, the method comprising the steps of:
forming a polymeric heterogeneous support medium having at least two regions which are heterogeneous;
placing the heterogeneous support medium under recording conditions which are selected to change one or more physical properties of the heterogeneous support medium, wherein the extent or nature of the change in the physical property or physical properties is different in at least two of the heterogeneous regions;
recording a holographic image in the heterogeneous support medium while it is under recording conditions; and
removing the heterogeneous support medium from recording conditions.

2. (canceled)

3. The method according to claim 1, wherein the heterogeneous support medium is formed by:
a) polymerisation of monomers, wherein different monomers are used to form each heterogeneous region of the support medium; and/or
b) polymerisation of monomers, wherein different polymerisation reaction conditions are used to form each heterogeneous region of the support medium; and/or
c) modification of a support medium by introducing into the support medium a component and reacting the component with the support medium or with a second component present in the medium, wherein a different extent of reaction occurs to form each heterogeneous region of the support medium.

4. The method according to claim 3, wherein the heterogeneous support medium is formed by c) and the extent of reaction occurring to form each heterogeneous region of the support medium is varied by varying the concentration of or duration of contact with the component.

5. The method according to claim 3, wherein the heterogeneous support medium is formed by a).

6. The method according to claim 1, wherein the heterogeneous support medium comprises at least 50 heterogeneous regions.

7. The method according to claim 6, wherein the extent or nature of the change in the physical property or physical properties of the heterogeneous support medium is different in at least 80% of the heterogeneous regions.

8. The method according to claim 1, wherein recording conditions are selected from non-ambient temperature, non-atmospheric pressure, a magnetic field, an electric field and immersion in a recording liquid.

9. The method according to claim 1, wherein the recording conditions include immersion in a recording liquid that comprises at least 3 components, wherein each component interacts with the heterogeneous support medium to change one or more of its physical properties, wherein the extent or nature of the interaction of at least two of the heterogeneous regions of the support medium is different and wherein the change in one or more physical properties of the heterogeneous support medium is caused by a physical or chemical interaction with at least one component in the recording liquid.

10-11. (canceled)

12. A holographic device obtainable by a method according to claim 1.

13. The device according to claim 12, wherein the holographic image is generated by the diffraction of light.

14. The device according to claim 12, wherein the holographic image is only visible under magnification.

15. (canceled)

16. The device according to claim 12, further comprising means for producing an interference effect when illuminated with laser light.

17-19. (canceled)

20. The device according to claim 12, wherein the device has an optical filter thereon.

21. (canceled)

22. A method of verifying the authenticity of a holographic device or of a recording condition, the method comprising subjecting a device according to claim 12 to recording conditions; and observing the holographic image.

23-24. (canceled)

25. An article comprising a device according to claim 12.

26-30. (canceled)

31. A transferable holographic film comprising a holographic device according to claim 12.

32. (canceled)

33. The method according to claim 3, wherein the heterogeneous support medium is formed by c) and wherein the component is a cross-linker that is activated photochemically using a greyscale mark.

34. The method according to claim 3, wherein the heterogeneous support medium is formed by the polymerisation of monomers, the said component being an additional monomer.

35. The method according to claim 1, wherein the heterogeneous support medium is cross-linked.

36. The method according to claim 1, wherein the heterogeneous support medium is formed as spots on a substrate.

37. A method of verifying the authenticity of an article containing a liquid, comprising attaching a device according to claim 12 to the article, wherein an image has been recorded in the device when in contact with the same liquid, contacting the device with a sample of the liquid from the article, and confirming that the image is visible.

38. A method of verifying the authenticity of a device according to claim 12, comprising contacting the device with a liquid known to be the recording liquid, and confirming that the image is visible.
